(19) United States
(12) Patent Application Publication
(10) Pub. No.: US 2025/0304029 A1
(43) Pub. Date: Oct. 2, 2025

(54) Kinetic Energy Conversion and Electric Power Generation System for Vehicles

(71) Applicant: Gary Bell, Rockford, IL (US)

(72) Inventor: Gary Bell, Rockford, IL (US)

(21) Appl. No.: 18/830,710

(22) Filed: Sep. 11, 2024

Related U.S. Application Data
(60) Provisional application No. 63/570,274, filed on Mar. 27, 2024.

(51) Int. Cl. B60W 10/26; B60W 20/13

(52) U.S. Cl. CPC B60W 10/26; B60W 20/13

(57) ABSTRACT

An electric energy generation system for vehicles that harnesses kinetic energy produced by the motion of the vehicle's wheels to generate electricity is disclosed. The system includes a chain connected to at least one wheel and a generator, which converts the transmitted kinetic energy into electric power. The generated electricity is stored in a battery, with an alternator regulating the battery charge to prevent overcharging and overheating. A shaft ensures alignment and efficient operation of the generator and alternator. The system also features a control unit that automatically activates the generator when the vehicle is in motion and manages the energy conversion and storage processes. Additional features include a user interface accessible via a mobile application for real-time monitoring and diagnostics, and a manual control button on the vehicle's dashboard.

### CROSS-REFERENCE TO RELATED APPLICATION

The present application claims priority to, and the benefit of, U.S. Provisional Application No. 63/570,274, which was filed on Mar. 27, 2024, and is incorporated herein by reference in its entirety.

### FIELD OF THE INVENTION

The present invention generally relates to the field of electric energy generation systems for vehicles. More specifically, the present invention relates to a novel system designed to harness kinetic energy from a vehicle's wheels to generate electricity. The system includes a chain connected to at least one wheel and a generator that converts kinetic energy into electric power, which is stored in a battery. An alternator regulates the battery's charge, and a shaft ensures proper alignment and efficient operation of the generator and alternator. The system also features a control unit for automatic activation and real-time monitoring via a mobile application. Accordingly, the present disclosure makes specific reference thereto. Nonetheless, it is to be appreciated that aspects of the present invention are also equally applicable to other like applications, devices, and methods of manufacture.

### BACKGROUND

By way of background, Electric vehicles (EVs) are used for reducing environmental impact and dependence on fossil fuels. Unlike conventional vehicles, which rely on gasoline or diesel, EVs run on electric power, resulting in zero emissions and significantly lower greenhouse gas emissions. However, despite their environmental benefits, electric vehicles face significant challenges that hinder their widespread adoption. One of the primary drawbacks is their limited driving range.

Current EV batteries require frequent recharging, which can be inconvenient for users, especially on long trips. As a result, EV owners often need to plan their routes carefully to include charging stations, which are not always conveniently located or widely available. The limitation of frequent charging necessitates frequent stops to recharge the vehicle's battery, leading to delays and inconvenience for travelers. On long-distance journeys, drivers are compelled to seek out roadways with charging infrastructure every few hundred miles to ensure they do not run out of battery charge. Individuals desire an innovative solution to overcome the charging limitations by providing a system that continuously charges the vehicle's battery while in motion.

Therefore, there exists a long-felt need in the art for an improved system for generating electric energy in vehicles. There is also a long-felt need in the art for a solution that continuously charges an electric vehicle's battery while in motion, extending the vehicle's driving range. Additionally, there is a long-felt need in the art for a kinetic energy conversion system that can be integrated into both new and existing vehicles, making it a versatile aftermarket accessory. Moreover, there is a long-felt need in the art for an energy generation system that reduces the frequency of charging stops, thereby decreasing travel time and increasing convenience for drivers. Further, there is a long-felt need in the art for a system that optimizes energy conversion efficiency and ensures the safe operation of the vehicle's electrical components. Furthermore, there is a long-felt need in the art for a control unit that provides real-time monitoring, diagnostics, and user-friendly controls to enhance the user experience. Finally, there is a long-felt need in the art for a robust and reliable energy generation system that addresses the challenges of limited driving range and charging infrastructure, providing a comprehensive solution to the constraints faced by electric vehicle users.

The subject matter disclosed and claimed herein, in one embodiment thereof, comprises an electric energy generation system for a vehicle. The system is designed to convert kinetic energy of wheels of the vehicle into electric power and comprises at least one chain adapted to connect at least one wheel of the vehicle to a generator, the generator is configured to produce electricity when rotated by the chain, a battery is configured to store the electricity generated by the generator, an alternator coupled to the generator is adapted to regulate the charge of the battery, and a control unit is adapted to control the operation of the system, automatically activating the system when the vehicle is in motion and converting kinetic energy into electrical power. The system can also be controlled remotely using a mobile application installed in a mobile device.

In this manner, the electric energy generation system of the present invention accomplishes all of the foregoing objectives and provides users with a novel solution for continuously charging electric vehicle batteries while in motion. The system includes a chain connected to at least one wheel of the vehicle, which transmits kinetic energy to a generator as the vehicle moves. The generator converts the kinetic energy into electric power, which is stored in a battery for use by the vehicle's motor and other electrical systems. An alternator is coupled to the generator to regulate the battery's charge, preventing overcharging and overheating. A shaft ensures proper alignment and efficient operation of the generator and alternator. Additionally, a control unit manages the system, automatically activating it when the vehicle is in motion and providing real-time monitoring and diagnostics via a mobile application. This comprehensive system can be integrated into new vehicles during manufacturing or used as an aftermarket accessory, suitable for various types of electric vehicles, including cars, trucks, buses, and tractors.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an electric energy generation system for a vehicle. The system comprises a chain adapted to connect at least one wheel of the vehicle to a generator, the generator is configured to produce electricity when rotated by the chain, a battery is configured to store the electricity generated by the generator, an alternator coupled to the generator is adapted to regulate the charge of the battery, and a control unit is adapted to control the operation of the system, automatically activating the system when the vehicle is in motion and converting kinetic energy into electrical power.

In yet another embodiment, a method for generating electric energy in a vehicle is disclosed. The method includes the steps of connecting a chain to at least one wheel of the vehicle and a generator, rotating the chain with the motion of the vehicle's wheel to drive the generator, generating electricity with the generator and storing it in a battery, regulating the charge of the battery using an alternator coupled to the generator, and controlling the system with a control unit that automatically activates the system when the vehicle is in motion.

In another embodiment, a system for converting kinetic energy from a vehicle into electric power is disclosed. The system comprises at least one wheel of the vehicle adapted to generate kinetic energy as the vehicle moves, a chain connected to the at least one wheel, configured to transmit the kinetic energy, a generator driven by the chain, adapted to convert the transmitted kinetic energy into electric power, a battery configured to store the electric power generated by the generator, and an alternator coupled to the generator.

In still another embodiment, the chain is looped along an additional rim of the wheel, forming a closed loop.

In another aspect, the system includes a user interface displayed by a mobile application for providing real-time status, energy efficiency, and diagnostic information of the system.

In yet another aspect, the system is installed underneath the vehicle and does not interfere with the vehicle's operation.

In another embodiment, the control unit includes a control button on the vehicle's dashboard for manual activation and deactivation of the device.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of the electric energy generation system of the present invention for vehicles in accordance with the disclosed structure;

FIG. 2 illustrates a perspective view of one potential embodiment of the electric energy generation system of the present invention for vehicles in accordance with the disclosed structure;

FIG. 3 illustrates an exemplary user interface displayed by a mobile application coupled to the system for providing real-time status of the system in accordance with the disclosed structure;

FIG. 4 illustrates a perspective view showing the control element disposed inside the vehicle for controlling the system in accordance with the disclosed structure; and

FIG. 5 illustrates a flow chart depicting a process of operation of the electric power generation system of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved system for generating electric energy in vehicles. There is also a long-felt need in the art for a solution that continuously charges an electric vehicle's battery while in motion, extending the vehicle's driving range. Additionally, there is a long-felt need in the art for a kinetic energy conversion system that can be integrated into both new and existing vehicles, making it a versatile aftermarket accessory. Moreover, there is a long-felt need in the art for an energy generation system that reduces the frequency of charging stops, thereby decreasing travel time and increasing convenience for drivers. Further, there is a long-felt need in the art for a system that optimizes energy conversion efficiency and ensures the safe operation of the vehicle's electrical components. Furthermore, there is a long-felt need in the art for a control unit that provides real-time monitoring, diagnostics, and user-friendly controls to enhance the user experience. Finally, there is a long-felt need in the art for a robust and reliable energy generation system that addresses the challenges of limited driving range and charging infrastructure, providing a comprehensive solution to the constraints faced by electric vehicle users.

The present invention, in one exemplary embodiment, is a system for converting kinetic energy from a vehicle into electric power. The system comprises at least one wheel of the vehicle adapted to generate kinetic energy as the vehicle moves, a chain connected to the at least one wheel, configured to transmit the kinetic energy, a generator driven by the chain, adapted to convert the transmitted kinetic energy into electric power, a battery configured to store the electric power generated by the generator, and an alternator coupled to the generator.

Reference will now be made in detail to the present preferred embodiments of the invention, examples of which are illustrated in the accompanying drawings. Wherever possible, the same reference numerals are used in the drawings and the description to refer to the same or like parts.

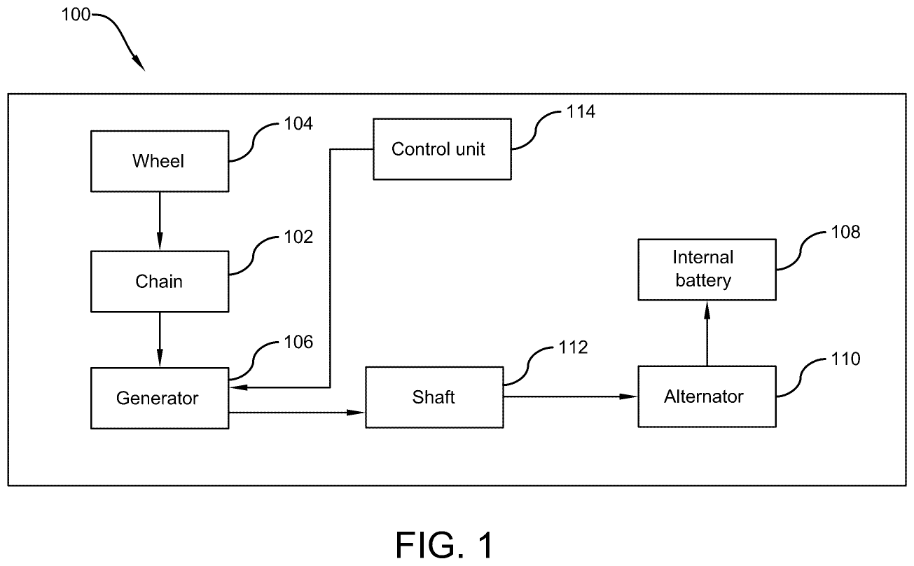

Referring initially to the drawings, FIG. 1 illustrates a schematic view of the electric energy generation system of the present invention for vehicles in accordance with the disclosed structure. The electric energy generation system 100 of the present invention is designed to harness kinetic energy produced by the motion of the vehicle's wheels to generate electricity, which then charges the vehicle's battery. More specifically, the electric energy generation system 100 comes in the form of a kit that can be integrated into a new vehicle during manufacturing of the vehicle or can also be used as an aftermarket accessory with the existing vehicles. The system 100 can be used with a wide range of electric vehicles, including cars, trucks, buses, tractors, and other residential and commercial vehicles.

The system 100 includes a chain 102 which is adapted to connect at least one wheel 104 of the vehicle to a generator 106. As the vehicle moves, the at least one wheel 104 turns and generates kinetic energy. The chain 102 is adapted to transmit kinetic energy from the wheel 104 to the generator 106. The generator 106 connected to the turning wheel 104 produces electricity that charges the internal battery 108 of the vehicle, enabling for continuous charging while the vehicle is in motion. The battery 108 is configured to store electrical energy generated by the generator 106. The battery 108 stores the electrical energy for providing a power source for the vehicle's motor and other electrical systems.

An alternator 110 is coupled to the generator 106 and is adapted to maintain battery charge. The alternator 110 enables that the electrical energy is properly regulated and helps in recharging the battery 108 as needed. The alternator 110 also helps in preventing overcharging of the battery 108, thereby preventing overheating and overcharging. A shaft 112 connects the generator 106 to the alternator 110 and provides alignment of the generator 106 and the alternator 110. The shaft 112 also helps in preventing overheating of the generator 106 and provides efficient operation of the alternator 110. The system 100 enables the vehicle to travel longer distances without the need to stop frequently for recharging, as the battery 108 is continuously replenished by the kinetic energy conversion process as described above.

A control unit 114 is adapted to control operation of the system 100 and regulates the energy conversion and storage processes. The control unit 114 automatically activates the system 100 when the vehicle starts to move to convert the kinetic energy into electrical power. In some embodiments, when the system 100 is not required, a control button as described later in the disclosure is used for manually activation and deactivation of the system 100.

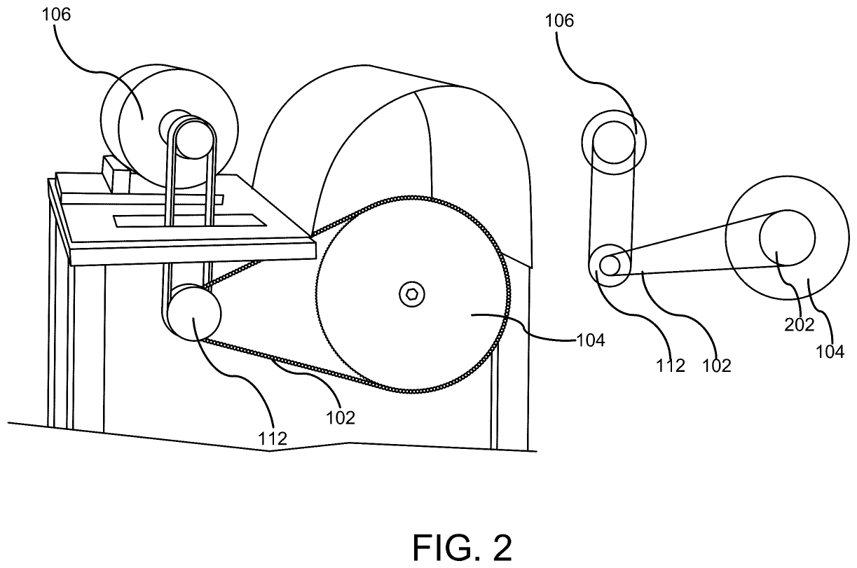

FIG. 2 illustrates a perspective view of one potential embodiment of the electric energy generation system of the present invention for vehicles in accordance with the disclosed structure. As illustrated, the chain 102 is looped along the wheel 104, preferably an additional rim 202 of the wheel 104. The chain 102 forms a closed loop along the wheel 104 and the shaft 112. The shaft 112 rotates and in turn rotates the generator 106 for producing electric power. It will be apparent to a person skilled in the art that the generator 106 can be coupled to both the rear wheels of the vehicle or both the rear wheels and front wheels of the vehicle. The system 100 is preferably installed underneath the vehicle and does not obstruct the functioning of the vehicle.

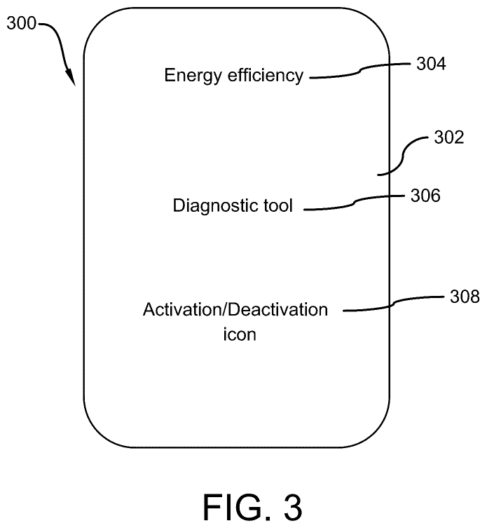

FIG. 3 illustrates an exemplary user interface displayed by a mobile application coupled to the kinetic energy conversion and electric power generation system for providing real-time status of the system in accordance with the disclosed structure. The user interface 302 is displayed by the application 300 which is adapted to be installed in a handheld computer device. The user interface 302 displays energy efficiency 304 of the system 100 and can indicate to the maintenance requirements of the kinetic energy conversion and electric power generation system 100. A diagnostic tool 306 provides diagnostic of the system 100 and can indicate the malfunctioned components in the system 100. An activation and deactivation icon 308 enables the application 300 to remotely activate and deactivate the system.

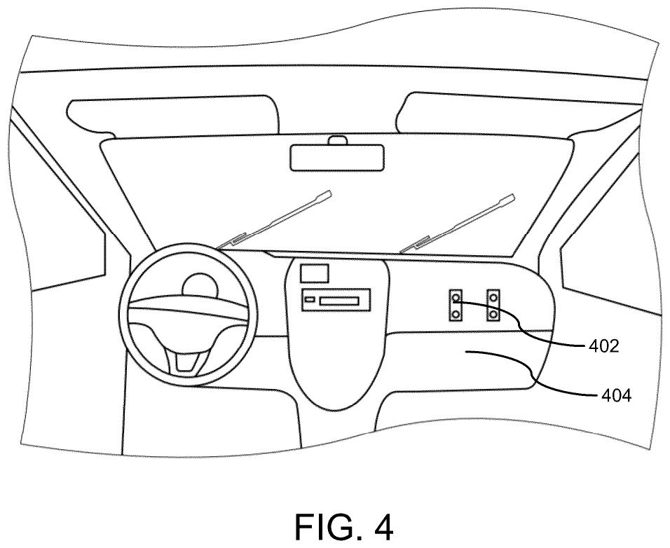

FIG. 4 illustrates a perspective view showing the control element disposed inside the vehicle for controlling the system in accordance with the disclosed structure. As illustrated, a control button 402 is disposed on the dashboard 404 for enabling a driver to manually activate and deactivate the system 100. The control button 402 can be coupled to electronic control unit (ECU) of the vehicle for an effective control of the system 100.

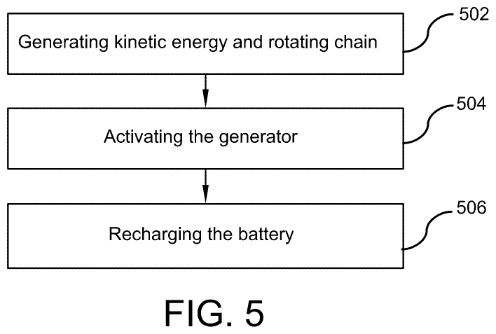

FIG. 5 illustrates a flow chart depicting a process of operation of the electric power generation system of the present invention in accordance with the disclosed structure. Initially, when the vehicle moves, the wheels of the vehicle generate kinetic energy and rotates the coupled chain (Step 502). Then, the chain rotates and moves the shaft along with the generator (Step 504). Specifically, the rotor of the generator rotates inside the stator to generate electric power using the kinetic energy. Thereafter, the electric power from the generator is transmitted to the battery of the vehicle to recharge the battery while the vehicle is in motion (Step 506). In the preferred embodiment, the generator has the efficiency between 80% and 90% and can recharge the battery of the vehicle up to 80% of the battery level in 4-5 hours.

The chains used in the continuous vehicular battery charging system 100 can be made of steel, nickel-plated steel, and any other similar material and the shaft can be made of steel or aluminum. All the components of the system 100 are resistant to moisture, chemicals, and temperature variations.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “continuous vehicular battery charging system”, “kinetic energy conversion and electric power generation system”, “electric energy generation system for vehicles”, and “system” are interchangeable and refer to the vehicular battery charging system 100 of the present invention.

Notwithstanding the forgoing, the vehicular battery charging system 100 of the present invention can be of any suitable size and configuration as is known in the art without affecting the overall concept of the invention, provided that it accomplishes the above stated objectives. One of ordinary skill in the art will appreciate that the vehicular battery charging system 100 as shown in the FIGS. are for illustrative purposes only, and that many other sizes and shapes of the vehicular battery charging system 100 are well within the scope of the present disclosure. Although the dimensions of the vehicular battery charging system 100 are important design parameters for user convenience, the vehicular battery charging system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electric energy generation system for harnessing kinetic energy comprising:
an electric vehicle;
at least one wheel;
a vehicle battery;
a chain; and
a generator;
wherein said chain connected to at least one wheel and said generator;
wherein said chain rotates when said electric vehicle is in motion and said at least one wheel is turning to generate kinetic energy;
wherein said chain transmits said kinetic energy from said at least one wheel to said generator;
wherein said generator connected to said vehicle battery; and
further wherein said generator continuously charges said vehicle battery when said electric vehicle is in motion.

2. The electric energy generation system for harnessing kinetic energy of claim 1, wherein said vehicle battery stores electrical energy generated by said generator.

3. The electric energy generation system for harnessing kinetic energy of claim 2, wherein said vehicle battery providing a power source for said electric vehicle.

4. The electric energy generation system for harnessing kinetic energy of claim 3 further comprising an alternator connected to said generator for maintaining a battery charge to said vehicle battery.

5. The electric energy generation system for harnessing kinetic energy of claim 4 further comprising a shaft connecting said generator to said alternator for providing alignment of said generator and said alternator.

6. The electric energy generation system for harnessing kinetic energy of claim 5 further comprising a control button for manual activation and deactivation of the electric energy generation system.

7. The electric energy generation system for harnessing kinetic energy of claim 6, wherein said chain looped around a rim of said at least one wheel.

8. The electric energy generation system for harnessing kinetic energy of claim 7, wherein said chain forming a closed loop along said at least one wheel and said shaft.

9. The electric energy generation system for harnessing kinetic energy of claim 8, wherein said shaft is a rotatable shaft for rotating a rotor in said generator for producing the electric power.

10. The electric energy generation system for harnessing kinetic energy of claim 9, wherein said chain having a material selected from the group consisting of a steel and a nickel-plated steel.

11. An electric energy generation system for harnessing kinetic energy comprising:
an electric vehicle;
at least one wheel;
a vehicle battery;
a chain;
a generator;
a shaft; and
an alternator;
wherein said chain connected to at least one wheel and said generator;
wherein said chain rotates when said electric vehicle is in motion and said at least one wheel is turning to generate kinetic energy;
wherein said chain transmits said kinetic energy from said at least one wheel to said generator;
wherein said generator connected to said vehicle battery;
wherein said alternator connected to said generator for maintaining a battery charge to said vehicle battery;
wherein said shaft connecting said generator to said alternator for providing alignment of said generator and said alternator; and
further wherein said generator continuously charges said vehicle battery when said electric vehicle is in motion.

12. The electric energy generation system for harnessing kinetic energy of claim 11, wherein said vehicle battery stores electrical energy generated by said generator, and further wherein said vehicle battery providing a power source for said electric vehicle.

13. The electric energy generation system for harnessing kinetic energy of claim 12 further comprising a control button for manual activation and deactivation of the electric energy generation system.

14. The electric energy generation system for harnessing kinetic energy of claim 13, wherein said chain looped around a rim of said at least one wheel.

15. The electric energy generation system for harnessing kinetic energy of claim 14, wherein said chain forming a closed loop along said at least one wheel and said shaft.

16. The electric energy generation system for harnessing kinetic energy of claim 15, wherein said shaft is a rotatable shaft for rotating a rotor in said generator for producing the electric power.

17. The electric energy generation system for harnessing kinetic energy of claim 16, wherein said control button coupled to an electronic control unit (ECU) of said electric vehicle.

18. A method of charging an electric vehicle battery, the method comprising the steps of:
providing an electric vehicle, at least one wheel, a vehicle battery, a chain, a generator, a shaft, and an alternator;
connecting said chain to at least one wheel and said generator;
rotating said chain when said electric vehicle is in motion and said at least one wheel is turning to generate kinetic energy;
transmitting with said chain said kinetic energy from said at least one wheel to said generator;
connecting said generator to said vehicle battery;
connecting said alternator to said generator for maintaining a battery charge to said vehicle battery, wherein said shaft connecting said generator to said alternator for providing alignment of said generator and said alternator; and
continuously charging said vehicle battery with said generator when said electric vehicle is in motion.

19. The method of charging an electric vehicle battery of claim 18, wherein said vehicle battery stores electrical energy generated by said generator, and further wherein said vehicle battery providing a power source for said electric vehicle.

20. The method of charging an electric vehicle battery of claim 19, wherein said shaft is a rotatable shaft for rotating a rotor in said generator for producing the electric power.
